(19) United States
(12) Patent Application Publication
(10) Pub. No.: US 2020/0300791 A1
(43) Pub. Date: Sep. 24, 2020

(54) MULTI-TIERED SYSTEMS AND METHODS FOR COMPOSITION ANALYSIS

(71) Applicant: General Electric Company, Schenectady, NY (US)

(72) Inventors: Adrian Ivan, Niskayuna, NY (US); Sergei Dolinsky, Clifton Park, NY (US)

(21) Appl. No.: 16/443,556

(22) Filed: Jun. 17, 2019

Related U.S. Application Data
(60) Provisional application No. 62/820,046, filed on Mar. 18, 2019.

(51) Int. Cl. G01N 23/2209; G01T 3/00

(52) U.S. Cl. CPC G01N 23/2209; G01T 3/001

(57) ABSTRACT

A diagnostic and inspection system is provided including a primary detection system, a secondary detection system, and at least one processor. The primary detection system is configured to acquire initial data of an object being analyzed. The secondary detection system includes at least one neutron source and at least one detector. The at least one detector is configured to acquire spectral emission data from the object generated responsive to neutrons provided by the at least one neutron source. The at least one processor is configured to acquire, from the primary detections system, the initial data from the object; determine a sub-portion of the object for further analysis using the initial data; direct at least one neutron beam from the at least one neutron source toward the sub-portion; acquire, from the secondary detector system, the spectral emission data from the object; and determine a presence of a substance using the spectral emission data.

### RELATED INVENTIONS

This application claims priority to U.S. Provisional Application Ser. No. 62/820,046, entitled “Multi-Tiered Systems and Methods for Composition Analysis,” filed Mar. 18, 2019, the subject matter of which is hereby incorporated by reference in its entirety.

### BACKGROUND OF THE INVENTION

The subject matter disclosed herein relates generally to systems and methods for inspection and diagnostic imaging, for example to identify explosives or other harmful materials.

Non-invasive screening of packages and luggage with high specificity for explosive material is an important priority for aviation and/or other security. As the number of air travelers increases, the number of false alarm events also increases, resulting in flight delays and negative passenger experience. Further, current approaches may not be as adaptable as desirable to evolving threats.

To address the baggage inspection issue, current aviation industry practice relies on a two-tiered inspection operation, first requiring all bags to go through a first-tier explosive detection system (EDS) tuned for high sensitivity and then transfering to the secondary tier the luggage that triggered alarms. Generally, two main approaches that are currently used for secondary inspection include a first approach of detecting trace quantities of molecules of explosive released in air or dispersed on surfaces, and a second approach relying on specific outcomes of x-rays interacting with an object being investigated, such as absorption, scattering, or diffraction of x-rays. Explosive trace detectors are based on ion spectrometry techniques. Such approaches, however, may be defeated by some new classes of explosives or by sealing against release of vapors. Further, collection of samples by contact or non-contact methods has a large variability in different environments and presents a challenge. With respect to the use of x-rays for secondary screening, the acquired data may be limited to material density and effective atomic number per voxel, leaving ambiguity in differentiating explosives from some types of common materials.

### BRIEF DESCRIPTION OF THE INVENTION

In one embodiment, a diagnostic system is provided that includes a primary detection system, a secondary detection system, and at least one processor. The primary detection system is configured to acquire initial data of an object being analyzed. The secondary detection system includes at least one neutron source and at least one gamma-ray detector or neutron detector. The at least one detector is configured to acquire spectral emission data from the object generated responsive to neutrons provided by the at least one neutron source. The at least one processor is configured to acquire, from the primary detection system, the initial data from the object; determine a sub-portion of the object for further analysis using the initial data; direct at least one neutron beam burst from the at least one neutron source toward the sub-portion; acquire, from the secondary detection system, the spectral gamma-ray emission data from the object; and determine a presence of a substance using the spectral emission data (e.g., determine with a sufficient probability confidence that the emission detected is compatible with a harmful (e.g., explosive) material hypothesis). The determination may be repeated or continued until the probability is above a threshold (for example, 95% or higher) set by the operator as signifying with sufficient confidence the presence of a harmful or contraband substance.

In another embodiment, a method is provided that includes acquiring initial data of an object being analyzed via a primary detection system. The method also includes determining a sub-portion of the object for further analysis using the initial data, and directing at least one neutron from at least one neutron source of a secondary detection system toward the sub-portion of the object. Further, the method includes acquiring spectral emission data from the object via at least one detector of the secondary detection system, and determining a presence of a substance using the spectral emission data.

### BRIEF DESCRIPTION OF THE DRAWINGS

FIG. 1 provides a schematic block diagram of a diagnostic system in accordance with various embodiments.

FIG. 2 provides a schematic view of a system including plural detectors in accordance with various embodiments.

FIG. 3 provides an example view of a neutron beam footprint in accordance with various embodiments.

FIG. 4 provides an example of a graph depicting ratios of different chemical elements in benign and harmful materials.

FIG. 5 provides a flowchart of a method in accordance with various embodiments.

### DETAILED DESCRIPTION OF THE INVENTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and preceded with the word “a” or “an” should be understood as not excluding plural of said elements or steps, unless such exclusion is explicitly stated. Furthermore, references to “one embodiment” of are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

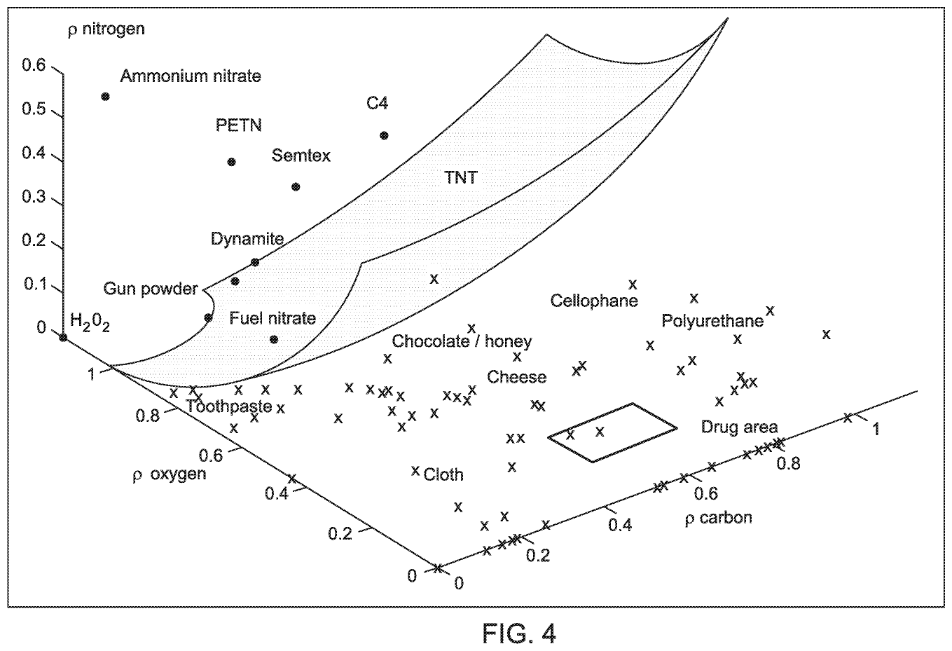

Various embodiments provide a multi-tiered approach to detection of one or more materials, such as explosives. For example, in various embodiments, objects are first processed through a first-tier explosive detection system (EDS) tuned for high sensitivity (e.g, a primary detection system), and then only objects that triggered an alarm are transferred to a subsequent tier (e.g., a secondary detection system) for further examination. The subsequent tier or secondary detection system is configured to detect explosive substances with extremely high specificity, thus distinguishing explosive substances with high confidence from benign materials. One challenge for such systems is the prevalence in explosives of low-Z chemical elements (e.g., N, 0, C) with similar concentrations in common substances, as illustrated in FIG. 4.

To achieve high specificity for secondary screening and to help defeat any concealing countermeasures, various embodiments use an intelligent active interrogation system, probing luggage, packages, and/or other objects with pulses of fast neutrons to detect high energy gamma rays emerging from nuclear reactions with nitrogen, carbon, and oxygen. In conjunction with prior data from primary screening, the composition of the object may be predicted with high accuracy.

In various embodiments, a trade-off between radioprotection concerns and the benefit of deep penetration of neutrons and high energy gamma rays is addressed by adopting a dose-sensitive, intelligent operation of a neutron generator source. For example, data from a primary screening (e.g., x-ray) may be utilized to start neutron probing only on a particular volume or region of an object identified as suspicious by the primary screening. Further, various embodiments employ a multi-step, on-off operation of a neutron source, such as by turning the neutron source on for a scout shot, turning off and analyzing data detected in response to the scout shot, deciding whether to proceed based on the analyzed data, and iterating until a desired confidence level is achieved, (e.g., as discussed in [0005] herein). The multi-step interrogation of the material reduces both the radiation dose near the secondary inspection system during operation and the potential delayed radioactivity induced in specific chemical elements that may be present in the object.

Various embodiments utilize the detection of prompt gamma rays in the energy range from about 4 to 11 MeV as offering improved signal to noise ratio for simultaneous nitrogen, carbon, and oxygen detection. Such a range is above the normal K-Th-U (potassium-thorium-uranium) gamma background, while high sensitivity detection of multi-MeV gammas from neutron-induced reactions is feasible using commercially available large scintillators coupled to photomultipliers or other types of photosensors.

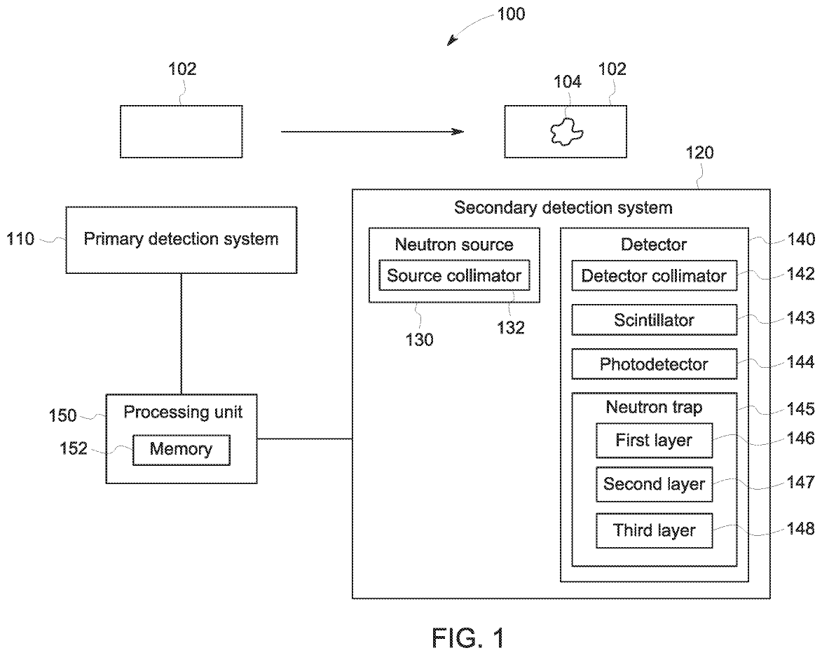

FIG. 1 provides a schematic block view of a diagnostic and inspection system 100 formed in accordance with various embodiments. The diagnostic system 100 includes a primary detection system 110, a secondary detection system 120 (which includes at least one neutron source 130 and at least one detector 140), and a processing unit 150. Generally, the diagnostic and inspection system 100 is used to identify the presence of one or more materials or compositions, such as explosives, narcotics, contraband, etc. For example, the diagnostic system 100 may be deployed at an airport or shipping facility, and used to inspect luggage and/or packages passing through the airport or shipping facility. The diagnostic system 100 is configured as a tiered system, including a first tier represented by the primary detection system 110 and a second tier represented by the secondary detection system 120. In various embodiments, the primary detection system 110 may be utilized to determine the possible presence of a material of interest as well as a particular volume of an examined item where the material of interest is located, and the secondary detection system 120 used to analyze the particular volume identified to confirm whether or not the material of interest is actually present.

In the illustrated embodiment, the primary detection system 110 is configured to acquire initial data of an object 102 (e.g., package or item of luggage) being analyzed. In various embodiments, the primary detection system 110 may be an x-ray system. The primary detection system 110 may be used to acquire the initial data, which may include data indicating whether there is a risk of an explosive or other harmful material within the object 102, as well as data describing, defining, or corresponding to the location of the potential harmful material within a sub-area and/or sub-volume of object 102. In the illustrated embodiment, sub-portion 104 of the object 102 indicates a location within the object 102 for which a potentially harmful material has been indicated by the primary detection system 110, with the primary detection system 110 utilized to determine the location and size of the sub-portion 104. If no potentially harmful materials are identified by the primary detection system 110, the object 102 may be further processed without being examined with the secondary detection system 120.

It may be noted that, in various embodiments, the initial data comprises depth data (e.g., identifying the location of portions of interest at a depth within the volume of the object 102), allowing improved positioning of the object 102 within the secondary detection system 120 and/or improved directing or shaping of the neutron beam from the secondary detection system 120.

The depicted secondary detection system 120 includes a neutron source 130 and a detector 140. It may be noted that in various embodiments, more than one neutron source 130 and/or more than one detector 140 may be employed. Generally the neutron source 130 is used to direct neutrons (e.g., via a neutron beam) toward the sub-portion 104 of the object 102. For example, the neutron source 130 may include or have associated therewith a source collimator 132 for directing neutrons emitted from the neutron source 130.

The detector 140 is configured to acquire spectral gamma-ray emission data from the object that is generated responsive to neutrons provided by the neutron source 130. In some embodiments, the detector 140 includes a detector scintillator 143 configured to generate light photons in response to photon or gamma ray impacts, and also include a photodetector 144 for detecting the light generated by the detector scintillator 143.

In various embodiments, the secondary detection system 120 (e.g., the detector 140) includes a neutron trap structure to help improve gamma detector sensitivity and to reduce spurious secondary gamma rays from an uncollided neutron beam transmitted through the object 102. For example, in the embodiment depicted in FIG. 1, the detector 140 includes a neutron trap 145. The depicted neutron trap 145 has three different layers—a first layer 146, a second layer 147, and a third layer 148. Each layer includes one or more corresponding materials configured to absorb or react with particular types of neutrons and/or gamma rays. For example, in the illustrated embodiment, the first layer 146 includes first materials that reduce fast neutron energy, the second layer 147 includes second materials that absorb slowed down neutrons, and the third layer 148 includes third materials that absorb energy of gamma rays emitted in the process of neutron capture.

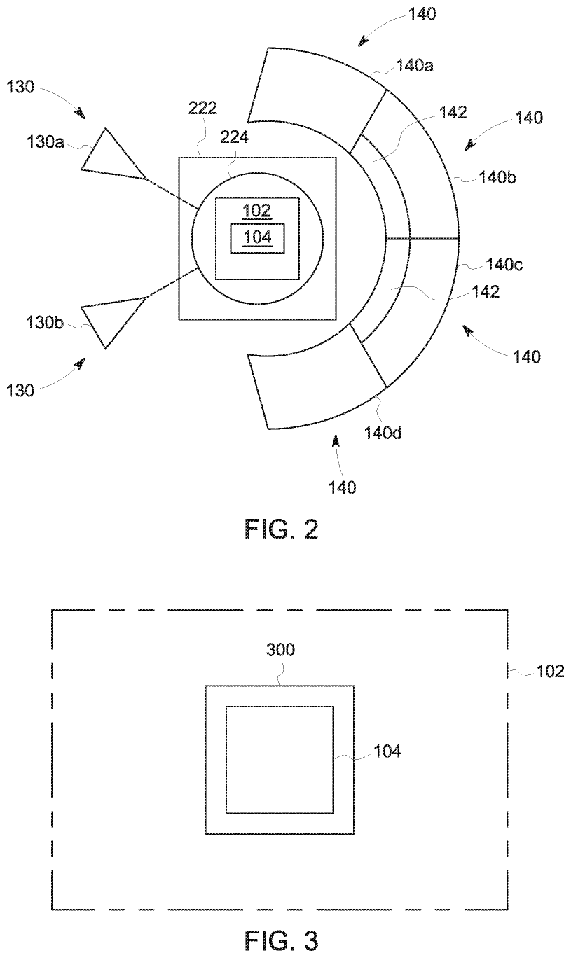

As discussed herein, in various embodiments more than one neutron source 130 and/or more than one detector 140 may be employed. For example, in various embodiments, the diagnostic system 100 includes plural detectors 140 configured to at least partially surround the object 102. FIG. 2 provides a schematic view of an embodiment of the diagnostic system 100 including plural detectors 140. As seen in FIG. 2, the diagnostic system includes detectors 140a, 140b, 140c, and 140d arranged as a semi-ring disposed about the object 102. It may be noted that other shapes (e.g., an “L” or “V” shape) may be used, or that a complete ring surrounding the object entirely may be used in various embodiments. Use of additional detectors helps to acquire more data (e.g., to improve signal-to-noise ratio) and may also be used to provide additional directionality data of emissions from the object 102. Additionally or alternatively, the diagnostic system 100 may include plural neutron sources. For example, the example diagnostic system 100 depicted in FIG. 2 includes two neutron sources—neutron source 130a and neutron source 130b. Plural neutron sources in various embodiments may be positioned around the object 102 for optimal positioning and/or direction of multiple neutron beams toward the sub-portion 104.

It may be noted that in various embodiments, data from the detector 140 is only used for determining spectral data, in which case spatial or directional data describing the shape of the sub-portion 104 may not be required. Accordingly, in such embodiments, collimation of gamma rays impacting the detector 140 of the secondary detection system 120 may be avoided to allow for increased or maximum numbers of detected events by the detector 140. However, in other embodiments, spatial data describing the sub-portion 104 from the detector 140 may be desirable. Accordingly, in some embodiments, one or more detectors 140 include a corresponding detector collimator, wherein the secondary detections system acquires secondary spatial data in addition to the spectral emission data. For example, as seen in FIG. 2, some of the detectors 140 (but not all in the illustrated embodiment) include or have associated therewith a detector collimator 142 configured to control the direction of gamma rays impacting the corresponding detector 140, by limiting the angles from which impacting rays may approach the corresponding detector 140. In other embodiments, each detector 140 may have an associated collimator 142, while in other embodiments, no detectors 140 may have an associated collimator 142.

In various embodiments, the secondary detection system 120 may be configured to position the object 102 in a preferred or ideal position for accurate and/or efficient scanning (e.g., to position the sub-portion 104 in a desired spatial relationship with one or more neutron beams emitted by the secondary detection system 120). For example, in the embodiment illustrated in FIG. 2, the secondary detection system 120 includes a translation system 222 (e.g., a system including a belt, rail, or other linear translation guide) and a rotation system 224 (e.g., a system including a turntable) configured to align the object 102 (e.g., the sub-portion 104) with a neutron beam emitted from the secondary detection system 120. Spatial data from the initial data acquired via the primary detection system 110 may be used to determine a preferred or optimal position for examination by the secondary detection system 120.

Returning to FIG. 1, the processing unit 150 includes at least one processor. In the illustrated embodiment, the processing unit 150 is operably coupled to the primary detection system 110 and secondary detection system 120, and receives data from the primary detection system 110 and the secondary detection system 120 as well as provides commands signals to control the operation of the primary detection system 110 and the secondary detection system 120. In various embodiments the processing unit 150 includes processing circuitry configured to perform one or more tasks, functions, or steps discussed herein. It may be noted that “processing unit” as used herein is not intended to necessarily be limited to a single processor or computer. For example, the processing unit 150 may include multiple processors, ASIC's, FPGA's, and/or computers, which may be integrated in a common housing or unit, or which may distributed among various units or housings. It may be noted that operations performed by the processing unit 150 (e.g., operations corresponding to process flows or methods discussed herein, or aspects thereof) may be sufficiently complex that the operations may not be performed by a human being within a reasonable time period. For example, the determination or identification of materials or compositions based on data acquired via the detector 140 may rely on or utilize computations that may not be completed by a person within a reasonable time period. The depicted processing unit 150 includes a memory 152. The memory 152 may include one or more computer readable storage media. The memory 152, for example, may store acquired emission data, results of intermediate processing steps, or the like. Further, the process flows and/or flowcharts discussed herein (or aspects thereof) may represent one or more sets of instructions that are stored in the memory 152 for direction of operations of the diagnostic system 100.

The depicted processing unit 150 is configured (e.g., programmed) to acquire the initial data from the object 102 via the primary detection system 110. For example, the processing unit 150 in various embodiments provides control signals to direct operations of the primary detection system 110 and receives data signals from the primary detection system 110 (e.g., signals from a detector of an x-ray system).

The processing unit 150 then determines or identifies the sub-portion 104 of the object 102 for further analysis using the initial data. For example, x-ray data may provide an indication of substantial or significant risk of an explosive device in a particular area or volume of the object 102. The processing unit 150, using the data received via the primary detection system 110, determines which portion or portions of the object 102 have the risk or potential for explosives or other harmful materials and identifies or defines the sub-portion 104 within the entire volume of the object 102. In various embodiments, the sub-portion 104 may be defined in 2 dimensions (as a cross-section throughout a dimension of the object 102), or in 3 dimensions (as a volume at a specified ranges of depths along three dimensions of the object 102).

The processing unit 150 is also configured to direct at least one neutron beam from the neutron source 130 toward the sub-portion 104. For example, in various embodiments, the processing unit 150 is configured to control the secondary detection system 120 to acquire the spectral emission data in an energy range from about 4 MeV to about 11 MeV. The processing unit 150 may send control signals to the neutron source 130 to control the energy of emissions for the neutron source 130. As discussed herein, such a range in various embodiments offers improved signal to noise ratio for simultaneous nitrogen, carbon, and oxygen detection.

As another example, in various embodiments, the processing unit 150 may control the source collimator 132 to shape the neutron beam emitted from the source collimator 132 and direct the neutron beam toward the sub-portion 104. In various embodiments, the secondary detection system 120 is configured to focus at least one neutron beam to a footprint complementary to the sub-portion 104. For example, the processing unit 150 may provide control signals to the source collimator 132 to control the position of one or more blades defining one or more apertures to provide the desired footprint for the neutron beam. FIG. 3 provides an example of such a footprint. In the example of FIG. 3, the sub-portion 104 defines a square shape, and the footprint 300 of the neutron beam is a square slightly larger (e.g., 5% or 10% larger in various embodiments) than the square defined by the sub-portion 104. In other embodiments, the footprint may be configured to precisely match the shape of the sub-portion 104 (or as closely as practically achievable). Generally, the closer the footprint 300 matches the sub-portion 104, the better the signal-to-noise ratio. Spatial data from the initial data acquired via the primary detection system 110 may be used to determine the desired footprint.

Exposure to the neutron beam results in emission of neutrons and/or gamma rays from the sub-portion 104 of the object 102, providing spectral emission data describing the response of the sub-portion 104 to the neutron beam at different energy levels along a spectrum of energy levels, which may be detected by the detector 140 of the secondary detection system 120. The spectral emission data may be represented by a chart or graph plotting event counts or gamma yield per neutron on one axis and gamma energy levels on another axis. The processing unit 150 then acquires the spectral emission data from the sub-portion 104 of the object 102 via the secondary detection system 120. For example, in various embodiments, the processing unit 150 provides control signals to direct operations of the secondary detection system 120 and receives data signals from the secondary detection system 120. It may be noted that exposing only the sub-portion 104 of the object 102 to the neutron beam helps reduce the time and expense of testing, as well as reducing the amount of dose released instantaneously and in delayed activation. Using the spectral emission data, the processing unit 150 next determines the probability of presence of a substance that is either harmful or benign. In various embodiments, the processing unit may calculate, based on a physical model employing the initial data, possible secondary detector output responses if different material compositions, including explosive or benign materials, occupy the sub-portion of the object, and compare the spectral emission data from the secondary detection system with the possible secondary detector output responses to identify a possible match.

For example, an explosive or other harmful material may have a known response along a spectrum of energies which may be catalogued as a spectral emission signature along with spectral emission signatures of other explosives or harmful substances. The processing unit 150 may store such signatures in a database (e.g., in memory 152) or be communicably coupled with an external source that includes a catalog of such signatures. The processing unit 150 may then compare the acquired spectral emission data with the signatures in the catalog or database, and, if the signature or profile of the acquired spectral emission data matches one or more catalogued signatures of harmful materials, identify the sub-portion 104 as having a harmful material.

It may be noted that, in various embodiments, the processing unit 150 is configured to determine (e.g., determine with a sufficient probability or at a sufficient confidence level) the presence of the substance based on a spectral signature corresponding to a ratio of two or more materials. For example, a ratio of densities of C, N, and O has been identified, as shown in FIG. 4, which is reproduced from FIG. 4 of “Neutron-Activated Gamma-Emission: Technology Review” by Marc Litz, Christopher Waits, and Jennifer Mullins, Army Research Laboratory, January 2012, the entire subject matter of which is hereby incorporated by reference in its entirety. Use of such ratios in various embodiments improves the ability to distinguish between explosives and harmless materials.

It may be noted that the processing unit 150 is depicted for ease of illustration as a single block; however, the processing unit 150 may include a number of processors housed in more than one physical unit. For example, the processing unit 150 may include one or more processors located in the same unit or structure as the primary detection system 110 and/or the neutron source 130 and/or the neutron detector 140, additionally or alternatively to a separately housed unit. Further, aspects of the processing unit 150 may be located remote from the detection system. Further it may be noted that the processing unit 150 may be configured to operate autonomously (e.g., without operator intervention), or may operate using interaction with an operator (e.g., by providing prompts and/or receiving commands from an operator).

It may be noted that some materials produce a relatively high level of radioactivity when exposed to a neutron beam, and it may be desirable not to irradiate such materials with a neutron beam. Accordingly, in various embodiments, the diagnostic system 100 is configured to identify instances of potentially excessive radiation and to use alternative methods of examination. For example, in various embodiments, the processing unit 150 is configured to perform a scout examination of the object 102 (e.g., of the sub-portion 104) with the secondary detection system 120 using a first, lower intensity of neutron beam. Then, the processing unit 150 determines a radioactivity level of emissions from the object 102 corresponding to the first low intensity. The processing unit 150 next determines whether or not to perform a diagnostic examination with the secondary detection system 120 using a second, higher intensity based on the radioactivity level determined using the scout examination. For example, if the radioactivity level from the scout scan exceeds a predetermined threshold, the object 102 may be determined as having a significant or substantial risk of excessive radiation, and the object 102 may be removed from the secondary detection system 120 and examined using a different technique. Accordingly, excessive radiation levels may be avoided.

It may further be noted that in various embodiments the processing unit 150 may use additional data in connection with the spectral emission data to help identify substances (e.g., potentially harmful substances such as explosives). For example, in various embodiments, the primary detection system is an x-ray detection system, and the processing unit 150 is configured (e.g., programmed) to acquire spatial data and supplemental data as parts of the initial data acquired via the primary detection system 110. The processing unit 150 may be configured to use the spatial data to determine the sub-portion 104 of the object 102, and to use the supplemental data from the primary detection system 110 along with the spectral emission data from the secondary detection system 120 to determine the presence of the substance. For example, the spatial data of the initial data may include a description of locations of potentially hazardous materials defining a volume or cross-sectional area of the object 102, while the supplemental data of the initial data from the primary detection system 110 may include data describing or corresponding to attenuation of x-rays within the object 102, which may be utilized by the processing unit 150 in conjunction with the spectral emission data from the secondary detection system 120 to identify the presence of a potentially harmful material such as an explosive.

Additionally or alternatively, in various embodiments, the processing unit 150 is configured to determine a shape of the object 102 (e.g., a shape of an item within the sub-portion 104 of the object 102) using the initial data from the primary detector system. Further, the processing unit 150 may determine expected spectral data based on the shape, and compare the expected spectral data with the acquired spectral emission data. For example, if a bottle shape is identified within the object 102 (e.g., within the sub-portion 104), the processing unit 150 may determine expected spectral data that corresponds to water or other liquids expected to be contained within a bottle. The processing unit 150 may then compare the actually acquired spectral emission data with the expected data, and if the two are different, the contents of the bottle may be identified as suspicious, and further examination performed on the bottle.

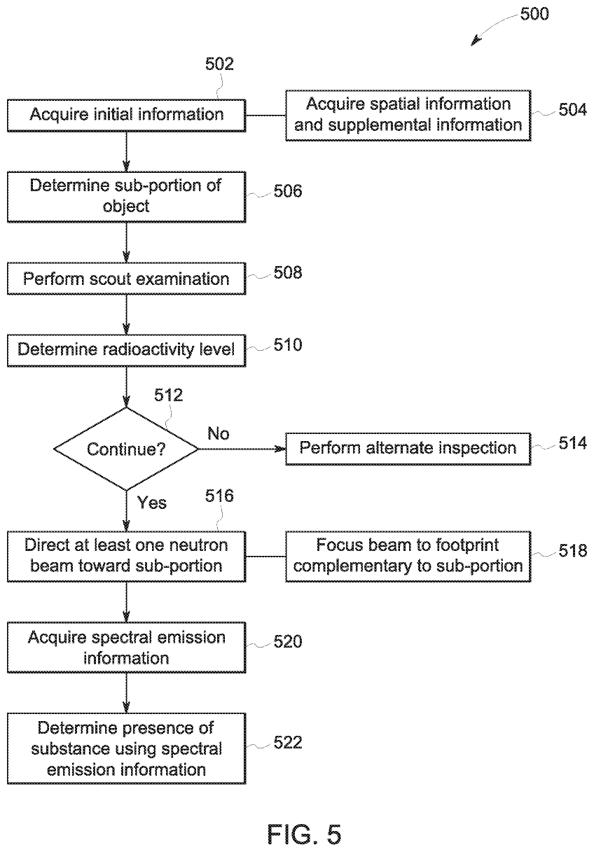

FIG. 5 provides a flowchart of a method 500 in accordance with various embodiments. The method 500, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method 500 may be able to be used as one or more algorithms to direct hardware (e.g., one or more aspects of the processing unit 150) to perform one or more operations described herein.

At 502, initial data is acquired of an object being analyzed with a primary detection system (e.g., primary detection system 110). The primary detection system, for example, may be an x-ray or CT system. In the illustrated embodiment, at 504, both spatial data (e.g., data corresponding to location within the object of potentially hazardous materials) and supplemental data (e.g., data regarding attenuation of the object) are acquired with the primary detection system.

At 506, a sub-portion of the object is determined for further analysis using the initial data. The sub-portion defines or corresponds to a portion of the object that has been identified has having a potential risk for having one or more designated substances (e.g., explosives). The size, shape, and/or location of the sub-portion may be determined in various embodiments using spatial data of the initial data. After identification of the sub-portion, the object may be transferred to a secondary detection system (e.g, secondary detection system 120). If no potentially hazardous materials are identified, the object may be approved for further processing or distribution without being analyzed by the secondary detection system.

At 508, a scout examination is performed with the secondary detection system. For example, the secondary detection system may direct a first lower intensity neutron beam toward the object. At 510, a radioactivity level corresponding to the first low intensity is determined. At 512, it is determined whether or not to perform a diagnostic examination with the secondary detection system using a second, higher intensity based on the radioactivity level determined using the scout examination. For example, if the radioactivity level exceeds a predetermined threshold, the secondary detection system may not be used for a diagnostic examination. If the secondary detection system is not to be used, the method 500 proceeds to 514, and an alternative inspection process is performed. If the secondary detection system is to be used, the method 500 proceeds to 516.

At 516, at least one neutron beam from at least one neutron source (e.g., neutron source 130) is directed toward the identified sub-portion of the object. In the illustrated embodiment, at 518, the at least one neutron beam is focused to a footprint complementary to the sub-portion (e.g., using a source collimator such as source collimator 132).

At 520, spectral emission data is acquired from the object via at least one detector (e.g., detector 140) of the secondary detection system. At 522, the presence (or absence) of a substance is determined using the spectral emission data. The presence of the substance may be determined, for example, using determined ratios of materials (e.g., C, N, O) as discussed herein. Depending on the determination at 522, subsequent processing of the object may be determined. For example, if explosives are identified, the object may be identified as having explosives and appropriately handled. If no explosives are identified, the object may be passed along to the next inspection step.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a processing unit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A diagnostic system comprising:
a primary detection system configured to acquire initial data of an object being analyzed;
a secondary detection system comprising
at least one neutron source; and
at least one detector configured to acquire spectral emission data from the object generated responsive to neutrons provided by the at least one neutron source; and
at least one processor configured to:
acquire, from the primary detection system, the initial data from the object;
determine a sub-portion of the object for further analysis using the initial data;
direct at least one neutron beam from the at least one neutron source toward the sub-portion;
acquire, from the secondary detection system, the spectral emission data from the object; and
determine with a sufficient probability confidence a presence of a substance using the spectral emission data from the secondary detection system.

2. The diagnostic system of claim 1, wherein the primary detection system is an x-ray detection system, and the at least one processor is configured to acquire spatial data and supplemental data with the primary detection system, use the spatial data to determine the sub-portion of the object; and use the supplemental data and the spectral emission data to determine the presence of the substance.

3. The diagnostic system of claim 1, wherein the at least one processor is configured to determine a shape of the object using the initial data from the primary detector system; determine expected spectral data based on the shape, and compare the expected spectral data with the acquired spectral emission data.

4. The diagnostic system of claim 1, wherein the at least one processor is configured to perform a scout examination of the object with the secondary detection system using a first, lower intensity; determine a radioactivity level corresponding to the first low intensity; and determine whether or not to perform a diagnostic examination with the secondary detection system using a second, higher intensity based on the radioactivity level determined using the scout examination.

5. The diagnostic system of claim 1, wherein the at least one processor is configured to control the secondary detection system to acquire spectral emission data in an energy range from about 4 MeV to about 11 MeV.

6. The diagnostic system of claim 1, wherein the at least one detector comprises plural detectors configured to at least partially surround the object.

7. The diagnostic system of claim 1, wherein the at least one processor is configured to determine the presence of the substance based on a spectral signature corresponding to a ratio of two or more elements of interest.

8. The diagnostic system of claim 1, wherein the secondary detection system comprises at least one of a translation system or a rotation system configured to align the object with the at least one neutron beam resulting in maximum signal/noise ratio for the spectral signature.

9. The diagnostic system of claim 1, wherein the secondary detection system is configured to focus the at least one neutron beam to a footprint complementary to the sub-portion.

10. The diagnostic system of claim 1, wherein the initial data comprises depth data.

11. The diagnostic system of claim 1, wherein the at least one detector comprises a neutron trap for the reduction of the gamma ray background incident on the detector.

12. The diagnostic system of claim 11, wherein the neutron trap comprises layers of first materials, second materials, and third materials, wherein the first materials reduce fast neutron energy, the second materials absorb slowed down neutrons, and the third materials absorb energy of gamma rays emitted in the process of neutron capture.

13. The diagnostic system of claim 1, wherein the at least one neutron source comprises plural neutron sources.

14. The diagnostic system of claim 1, wherein the at least one detector comprises at least one detector collimator, wherein the secondary detections system acquires secondary spatial data in addition to the spectral emission data.

15. A method comprising:
acquiring initial data of an object being analyzed via a primary detection system;
determining a sub-portion of the object for further analysis using the initial data;
calculating possible secondary detector responses for different material compositions occupying the sub-portion of the object;
directing at least one neutron beam from at least one neutron source of a secondary detection system toward the sub-portion of the object;
acquiring spectral emission data from the object via at least one detector of the secondary detection system; and
determining a presence of a substance using the spectral emission data.

16. The method of claim 15, wherein the primary detection system is an x-ray detection system, the method comprising:
acquiring spatial data and supplemental data with the primary detection system;
using the spatial data to determine the sub-portion of the object; and
using the supplemental data and the spectral emission data to determine the presence of the substance.

17. The method of claim 15, comprising:
determining a shape of the object using the initial data from the primary detector system;
determining expected spectral data based on the shape; and
comparing the expected spectral data with the acquired spectral emission data.

18. The method of claim 15, comprising
performing a scout examination of the object with the secondary detection system using a first, lower intensity;
determining a radioactivity level corresponding to the first low intensity; and
determining whether or not to perform a diagnostic examination with the secondary detection system using a second, higher intensity based on the radioactivity level determined using the scout examination.

19. The method of claim 15, comprising determining the presence of the substance based on a spectral signature corresponding to a ratio of two or more materials.

20. The method of claim 15, comprising focusing the at least one neutron beam to a footprint complementary to the sub-portion.
